(19) United States
(12) Patent Application Publication
(10) Pub. No.: US 2010/0007660 A1
(43) Pub. Date: Jan. 14, 2010

(54) Pattern inversion for improved resolution in 3D imaging

(76) Inventors: Arian Soroush Forouhar, Menlo Park, CA (US); Emilio Castano Graff, Altadena, CA (US); Francisco Pereira, Rome (IT); Morteza Gharib, San Marino, CA (US)

Correspondence Address: TOPE-MCKAY & ASSOCIATES;CARY TOPE-MCKAY, #311, 23852 Pacific Coast Highway, Malibu, CA, 90265, US

(21) Appl. No.: 12/460,167

(22) Filed: Jul. 13, 2009

Related U.S. Application Data
(60) Provisional application No. 61/134,698, filed on Jul. 11, 2008.

(51) Int. Cl. G06T 15/00; G06K 9/00

(52) U.S. Cl. 345/419; 382/154

(57) ABSTRACT

A system and method for improving resolution of a 3-D image by pattern inversion is disclosed. An image of a marker pattern transmitted from the surface of a 3-D object is captured with a sensor and analyzed using a 3-D image analysis method. The respective light and dark areas in the image are then inverted. The inverted image is then analyzed using a 3-D image analysis method, whereby the inversion allows for analysis of a greater portion of the image, resulting in a higher resolution 3-D image than without inversion.

### PRIORITY CLAIM

The present application is a non-provisional patent application, claiming the benefit of priority of U.S. Provisional Application No. 61/134,698, filed on Jul. 11, 2008, entitled, “PATTERN INVERSION FOR IMPROVED RESOLUTION IN 3D IMAGING.”

### FIELD OF INVENTION

The present invention relates three-dimensional (3-D) imaging and, more specifically, to a method and system for improving the resolution of a 3-D image by pattern inversion.

### BACKGROUND OF INVENTION

One of the current limitations of optical motion capture is 3-D spatial resolution. Traditional motion capture requires obtaining information regarding surface features from markers or sensors located on the object surface. The resolution of the 3-D image produced is therefore dependent on the number of markers on the object surface. Current methods for increasing spatial resolution of a 3-D image typically involve physically adding more markers or sensors to the observed object. This process can be very time consuming.

Thus, a continuing need exists for a method and system for increasing the resolution of a 3-D image without adding more markers or sensors to the object being imaged.

### SUMMARY OF INVENTION

The present invention relates three-dimensional (3-D) imaging and, more specifically, to a method and system for improving the resolution of a 3-D image by pattern inversion. In a first aspect, the present invention is a computer implemented method comprising a first act of capturing with a sensor a marker pattern transmitted by a 3-D object surface. The image is then analyzed using a 3-D image analysis method. Then, the image is inverted such that light and dark areas in the image are reversed. Finally, the inverted image is analyzed using a 3-D image analysis method, whereby the inversion allows for analysis of a greater portion of the image, resulting in a higher resolution 3-D image than without inversion.

In another aspect of the method, the marker pattern is of a type selected from the group consisting of natural features on the object, physical markers applied to the object surface, and a structured light pattern projected onto the object surface.

Another aspect of the present invention is a data processing system comprising at least one processor configured to perform the operations of the method of the present invention, as previously described.

In yet another aspect, the present invention is a complete imaging system comprising a sensor for capturing an image of a deformation of the projected pattern as transmitted by the object surface, and a data processing system for analyzing the captured images according to the method of the present invention to produce a high-resolution 3-D image.

In another aspect, the imaging system further comprises a projector for projecting a structured pattern of light onto the object surface as the marker pattern.

In a further aspect, the present invention embodies a computer program product comprising computer instruction means encoded on a computer-readable medium executable by a computer having a processor for causing the processor to perform the operations of the method of the present invention, as previously described.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 is a flow diagram showing the acts of the method of the present invention;

FIG. 2A is an illustration of an image of a projected light pattern in accordance with the present invention;

FIG. 2B is an illustration of an inverted image of a projected light pattern in accordance with the present invention;

FIG. 3 is a block diagram showing the components of a data processing system in accordance with the present invention;

FIG. 4 is an illustration showing a complete imaging system according to the present invention; and

FIG. 5 is an illustration showing examples of computer program products according to the present invention.

### DETAILED DESCRIPTION

The present invention relates three-dimensional (3-D) imaging and, more specifically, to a method and system for improving the resolution of a 3-D image by pattern inversion. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

### (1) Description

The present invention relates three-dimensional (3-D) imaging and, more specifically, to a method and system for improving the resolution of a 3-D image by pattern inversion. One of the current limitations of optical motion capture is 3-D spatial resolution. The present invention provides an optical method to increase resolution without adding additional markers to the observed object.

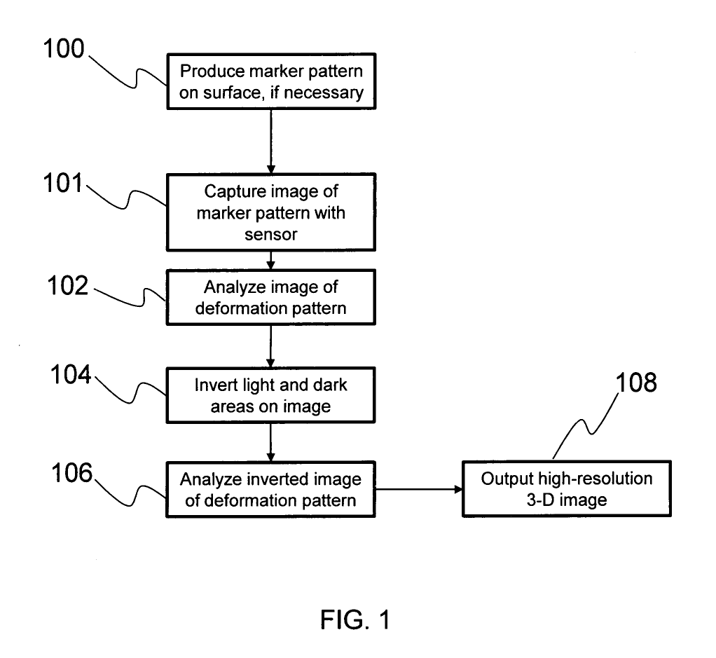

FIG. 1 is a flow diagram showing the acts in the method of the present invention. The method begins by producing 100 a marker pattern on the surface of a 3-D object. The marker pattern can be existing natural features already on the object, physical markers placed on the object surface such as painted or glued-on dots, or a structured pattern of light projected onto the object surface. An image of the marker pattern, as transmitted by the object surface, is captured by a sensor 101 and analyzed 102 using any of a variety of commercially available methods, such as but not limited to defocusing cameras, numerous single-lens cameras calibrated spatially and temporally, and interferometers. This initial analysis 102 will reveal information about the light areas in the image, which will yield information necessary to construct a 3-D image. Information about the dark areas in the image, however, is still unknown. Therefore, the next act in the method is to invert 104 the light and dark areas in the image, such that areas which were previously dark are now light, and vice versa. The inverted image is then analyzed 106 using any of the image analysis methods previously described. This second analysis 106 will reveal information about regions of the image not analyzed in the first analysis. Using this inversion technique, the resolution of the 3-D image produced 108 is approximately doubled by providing both information regarding the deformation of the projected light pattern, as well as information regarding the dark spaces in between the projected light pattern.

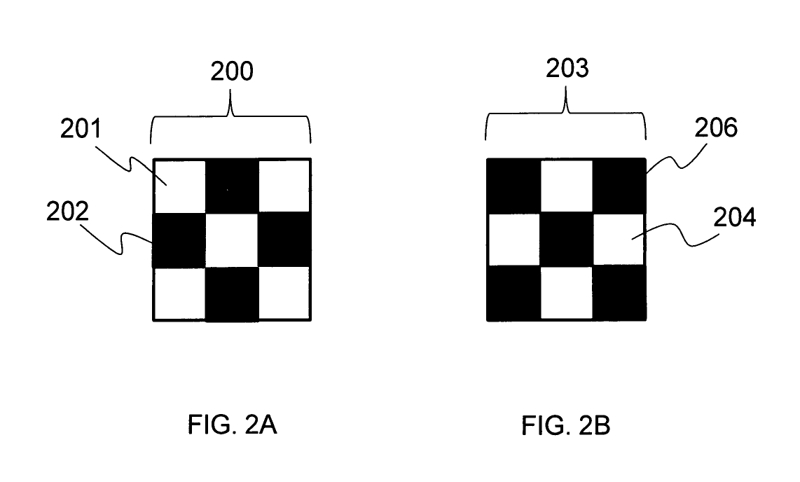

FIG. 2A is an illustration showing a non-limiting example of an initial image 200 created by a projected light pattern of five lights. The five light squares 201 represent portions of the image which are illuminated by the projected pattern of light, while the dark squares 202 represent gaps in between the light pattern where no image information is available. Assuming that the image processing software takes information from the light areas, the image in FIG. 2A provides information regarding five of the nine regions in the image.

FIG. 2B is an illustration showing an inversion 203 of the image from FIG. 2A. In FIG. 2B, the light 204 and dark 206 squares are opposite that in FIG. 2A. The image in FIG. 2B will supply image data regarding the four illuminated squares 204, which complements the image data from the initial image 200 in FIG. 2A. The system now has image data regarding all nine regions of the image frame, allowing production of a higher resolution image than would be produced by only the initial image 200. The same principle technique applies to non-projected marker patterns such as natural features or markers physically added to the object surface.

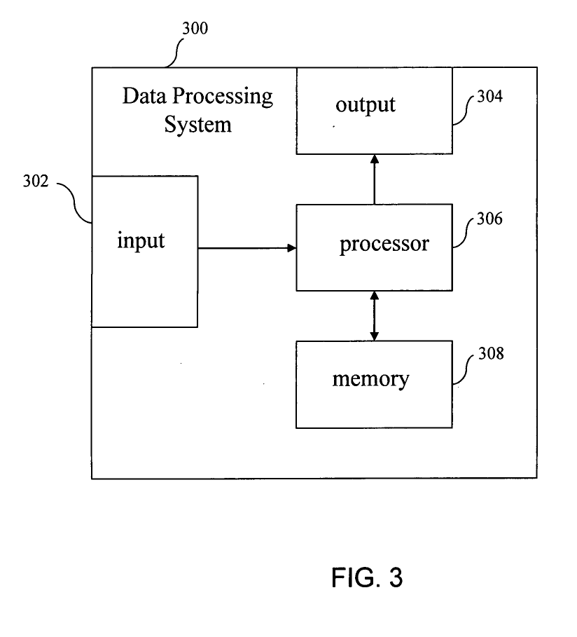

As can be appreciated by one skilled in the art, the present invention also comprises a data processing system for executing the method of the present invention, as previously mentioned. A block diagram depicting the components of an image processing system of the present invention is provided in FIG. 3. The image processing system 300 comprises an input 302 for receiving information from at least one sensor for use in detecting image intensity in an image. Note that the input 302 may include multiple “ports.” Typically, input is received from at least one sensor, non-limiting examples of which include image and video image sensors. An output 304 is connected with the processor for providing information regarding the presence and 3-D information of features in the image to other systems in order that a network of computer systems may serve as an image processing system. Output may also be provided to other devices or other programs; e.g., to other software modules, for use therein. The input 302 and the output 304 are both coupled with a processor 306, which may be a general-purpose computer processor or a specialized processor designed specifically for use with the present invention. The processor 306 is coupled with a memory 308 to permit storage of data and software that are to be manipulated by commands to the processor 306.

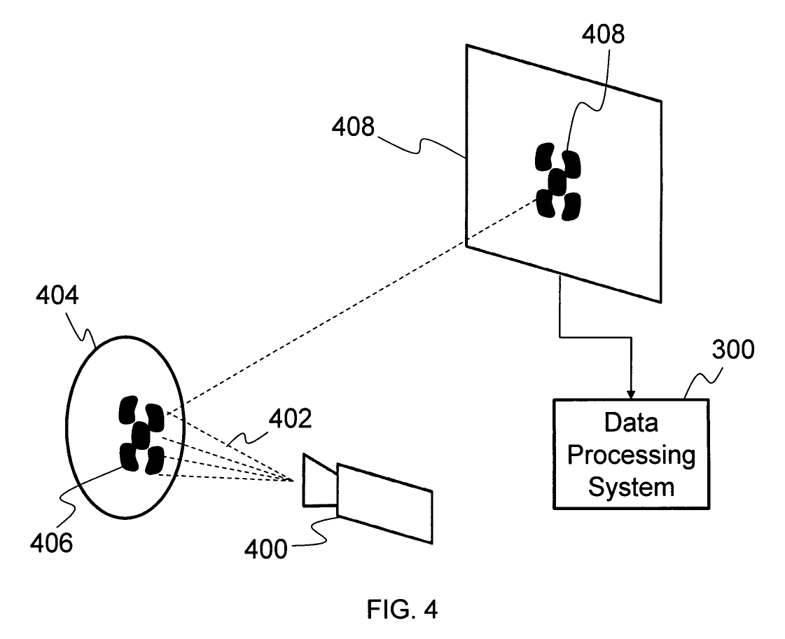

The data processing system described above can be used in conjunction with a complete imaging system as shown in FIG. 4. The system comprises a projector 400 for projecting a structured light pattern 402 onto an object 404, producing a deformed light pattern 406 on the surface of the object 404. At least one sensor 408 captures an image of the deformed light pattern 410 transmitted from the surface of the object 404, and a data processing system 300 as previously described analyzes the captured image 408 of the deformed light pattern in accordance with the method of the present invention. It should be noted that the light projector is an optional component of this system. In lieu of a projected pattern of light, other types of marker patterns such as natural features on the object surface or physical markers applied to the object surface can be used.

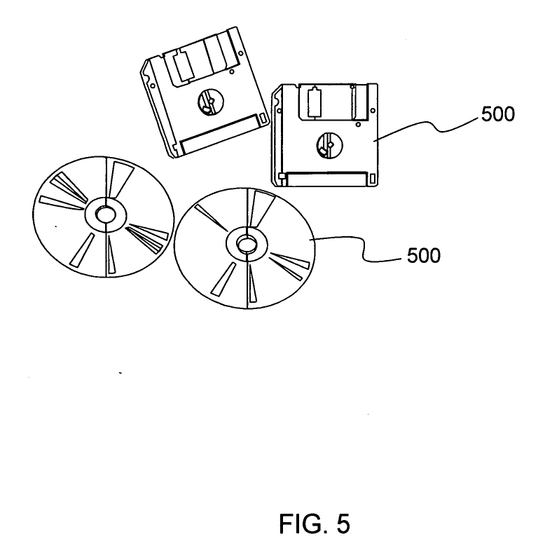

The present invention also comprises a computer program product. An illustrative diagram of a computer program product embodying the present invention is depicted in FIG. 5. The computer program product 500 is depicted as an optical disk such as a CD or DVD. However, as mentioned previously, the computer program product generally represents computer-readable instruction means stored on any compatible computer-readable medium. The term “instruction means” as used with respect to this invention generally indicates a set of operations to be performed on a computer, and may represent pieces of a whole program or individual, separable, software modules. Non-limiting examples of “instruction means” include computer program code (source or object code) and “hard-coded” electronics (i.e. computer operations coded into a computer chip). The “instruction means” may be stored in the memory of a computer or on a computer-readable medium such as a floppy disk, a CD-ROM, and a flash drive.

What is claimed is:

1. A computer-implemented method for increasing the resolution of a three-dimensional (3-D) image, comprising an act of causing a processor to perform operations of:
capturing with a sensor an image of a marker pattern as transmitted by a 3-D object surface;
analyzing the image of the marker pattern using a 3-D image analysis method;
inverting the image such that light and dark areas are reversed; and
analyzing the inverted image using a 3-D image analysis method, whereby the inversion allows for analysis of a greater portion of the image, thereby resulting in a higher resolution 3-D image than without inversion.

2. The method of claim 1, wherein the marker pattern is of a type selected from the group consisting of natural features on the object, physical markers applied to the object surface, and a structured light pattern projected onto the object surface.

3. A data processing system for increasing the resolution of a three-dimensional (3-D) image, comprising at least one processor configured to perform operations of:
capturing with a sensor an image of a marker pattern as transmitted by a 3-D object surface;
analyzing the image of the marker pattern using a 3-D image analysis method;
inverting the image such that light and dark areas are reversed; and
analyzing the inverted image using a 3-D image analysis method, whereby the inversion allows for analysis of a greater portion of the image, resulting in a higher resolution 3-D image than without inversion.

4. The method of claim 3, wherein the marker pattern is of a type selected from the group consisting of natural features on the object, physical markers applied to the object surface, and a structured light pattern projected onto the object surface.

5. A system for producing an increased-resolution three-dimensional (3-D) image, comprising:
at least one sensor for capturing an image of a marker pattern as transmitted by a 3-D object surface; and
a data processing system comprising at least one processor configured to perform operations of:
analyzing the image of the marker pattern using a 3-D image analysis method;
inverting the image such that light and dark areas are reversed; and
analyzing the inverted image using a 3-D image analysis method, whereby the inversion allows for analysis of a greater portion of the image, resulting in a higher resolution 3-D image than without inversion.

6. The system of claim 5, further comprising a projector for projecting a structured light pattern onto the surface of the 3-D object as the marker pattern.

7. A computer program product for increasing the resolution of a three-dimensional (3-D) image, comprising computer instruction means encoded on a computer-readable medium executable by a computer having a processor for causing the processor to perform operations of:
capturing with a sensor an image of a marker pattern as transmitted by a 3-D object surface;
analyzing the image of the marker pattern using a 3-D image analysis method;
inverting the image such that light and dark areas are reversed; and
analyzing the inverted image using a 3-D image analysis method, whereby the inversion allows for analysis of a greater portion of the image, resulting in a higher resolution 3-D image than without inversion.

8. The computer program product of claim 7, wherein the marker pattern is of a type selected from the group consisting of natural features on the object, physical markers applied to the object surface, and a structured light pattern projected onto the object surface.
